(19) United States
(12) Patent Application Publication
(10) Pub. No.: US 2026/0097598 A1
(43) Pub. Date: Apr. 9, 2026

(54) RECORDING DEVICE

(71) Applicant: SEIKO EPSON CORPORATION, Tokyo (JP)

(72) Inventor: Katsunari KUMAGAI, OKAYA-SHI (JP)

(21) Appl. No.: 19/350,189

(22) Filed: Oct. 6, 2025

(30) Foreign Application Priority Data
Oct. 7, 2024 (JP) 2024-176078

(51) Int. Cl. B41J 19/00; B41J 19/20; B41J 25/00; B41J 29/13

(52) U.S. Cl. CPC B41J 19/005; B41J 19/20; B41J 25/001; B41J 29/13

(57) ABSTRACT

A recording device includes a recording head that performs recording on a medium; a carriage that includes the recording head and that moves in a first direction which is a direction along a first axis and a second direction which is a direction along the first axis and which is opposite to the first direction; and an endless belt configured to pull the carriage in the first direction and in the second direction, wherein the carriage includes a belt fixing section that fixes the endless belt and a belt accommodation section that accommodates a part of the endless belt in a curved manner.

The present application is based on, and claims priority from JP Application Serial Number 2024-176078, filed October 7, 2024, the disclosure of which is hereby incorporated by reference herein in its entirety.

### BACKGROUND

### 1. Technical Field

The present disclosure relates to a recording device for recording on a medium.

### 2. Related Art

As disclosed in JP-A-2015-127100, there is a recording device represented by an inkjet printer in which a carriage having a recording head is pulled by an endless belt. The endless belt is wound around a drive pulley and a driven pulley. The carriage is provided with a gripping section that grips the endless belt.

If the specifications of the product are different, it is necessary to use endless belts having different circumferential lengths, and therefore, it is necessary to use an endless belt dedicated to each product, which complicates management and increases cost.

### SUMMARY

To solve the above problem, a recording device of the present disclosure includes a recording head that performs recording on a medium; a carriage that includes the recording head and moves in a first direction that is a direction along a first axis and a second direction which is a direction along the first axis and which is opposite to the first direction; and an endless belt configured to pull the carriage in the first direction and in the second direction, wherein the carriage includes a belt fixing section that fixes the endless belt and a belt accommodation section that accommodates a part of the endless belt in a curved manner.

### BRIEF DESCRIPTION OF THE DRAWINGS

FIG. 1 is an external perspective view of a printer.

FIG. 2 is an external perspective view of the printer with a document transport section opened.

FIG. 3 is an external perspective view of the printer with a scanner section opened.

FIG. 4 is an external perspective view of the printer in which the operation panel is tilted upward.

FIG. 5 is an external perspective view of the printer in a state where a medium receiving tray is pulled out and a medium support is opened.

FIG. 6 is a perspective view of the recording unit with a housing removed.

FIG. 7 is a plan view of the recording unit with a housing removed.

FIG. 8A is a diagram showing a medium transport path in a recording unit.

FIG. 8B is a diagram showing the positional relationship of some of the components in FIG. 8A.

FIG. 9 is a diagram showing a state in which an ink tube is drawn around.

FIG. 10 is a perspective view of the back of the carriage.

FIG. 11 is a front view of a belt fixing section and a belt accommodation section.

### DESCRIPTION OF EMBODIMENTS

Hereinafter, the present disclosure will be generally described.

A recording device according to a first aspect includes a recording head that performs recording on a medium; a carriage that includes the recording head and moves in a first direction that is a direction along a first axis and a second direction which is a direction along the first axis and which is opposite to the first direction; and an endless belt configured to pull the carriage in the first direction and in the second direction, wherein the carriage includes a belt fixing section that fixes the endless belt and a belt accommodation section that accommodates a part of the endless belt in a curved manner.

According to this aspect, by accommodating a part of the endless belt in the belt accommodation section, the circumferential length of the endless belt can be shortened as compared with a case where a part of the endless belt is not accommodated in the belt accommodation section. By this, the endless belt can be used in common for a plurality of products having different specifications, and thus management is facilitated and an increase in cost can be suppressed.

Note that the term "circumferential length of the endless belt" as used herein means the circumferential length of the endless belt in the assembled state of the device, and the same applies to the following description unless otherwise specified.

According to this aspect, when the endless belt having a longer circumferential length than the circumferential length of the assembled device is used, the excess length of the endless belt can be accommodated in the belt accommodation section. In other words, even when the endless belt has an excess length, the excess length of the endless belt can be absorbed by the belt accommodation section. Therefore, the endless belt can be easily shared by a plurality of devices having different specifications.

A second aspect is an aspect according to the first aspect, wherein the endless belt includes a plurality of tooth sections arranged along a belt length direction, the belt fixing section includes an engagement section that engages with the tooth sections, and the belt accommodation section does not include an engagement section that engages with the tooth sections.

If the belt accommodation section is provided with the engagement section, a deflection portion may be formed between the belt fixing section and the belt accommodation section, and by this, the circumferential length of the endless belt may be different from an intended circumferential length.

However, according to this aspect, since the belt accommodation section is not provided with the engagement section, it is possible to suppress the circumferential length of the endless belt from being different from an intended circumferential length.

A third aspect is an aspect according to the second aspect, wherein the belt fixing section and the belt accommodation section are arranged side by side along the first axis, the endless belt includes a first portion extending from the belt fixing section in the first direction, a second portion extending from the belt fixing section in the second direction, a third portion extending from the belt accommodation section in the first direction, and a fourth portion extending from the belt accommodation section in the second direction, wherein the first portion, the second portion, the third portion, and the fourth portion are arranged linearly along the first axis.

When the endless belt is pulling the carriage, the first portion, the second portion, the third portion, and the fourth portion are portions that apply a force that attempts to rotate the carriage in a side view of the endless belt. Therefore, in a case where the respective portions are not arranged in a straight line along the first axis, the magnitude of the moment applied to the carriage is different when the carriage is pulled in the first direction and when the carriage is pulled in the second direction, and there is a concern that the recording quality may be adversely affected.

However, according to the present aspect, the first portion, the second portion, the third portion, and the fourth portion are linearly arranged along the first axis, and thus the adverse effect described above can be suppressed.

A fourth aspect is an aspect according to the first aspect, wherein assuming that the belt accommodation section is a first belt accommodation section, the carriage includes a second belt accommodation section in addition to the first belt accommodation section, the second belt accommodation section accommodating a part of the endless belt in a curved manner.

According to this aspect, since the second belt accommodation section that accommodates a part of the endless belt in a curved manner is provided separately from the first belt accommodation section, the degree of freedom in adjusting the circumferential length of the endless belt is further improved. Specifically, the circumferential length of the endless belt can be made different between when the endless belt is not accommodated in any of the first belt accommodation section and the second belt accommodation section, when the endless belt is accommodated in one of the first belt accommodation section and the second belt accommodation section, and when the endless belt is accommodated in both the first belt accommodation section and the second belt accommodation section.

Note that the present aspect is not limited to the first aspect and may be dependent on the second or third aspect.

A fifth aspect is an aspect according to the fourth aspect, wherein the belt fixing section, the first belt accommodation section, and the second belt accommodation section form a curved portion inside the endless belt or form a curved portion outside the endless belt.

In a case where the belt fixing section, the first belt accommodation section, and the second belt accommodation section form curved portions in the endless belt, three curved portions are formed in the endless belt in the carriage. Of these curved portions, for example, if the curved portion of the first belt accommodation section is located outside the endless belt and the curved portion of the second belt accommodation section is located inside the endless belt, the carriage needs to have spaces outside and inside the endless belt, which may increase the size of the carriage.

However, according to this aspect, since the belt fixing section, the first belt accommodation section, and the second belt accommodation section all form the curved portion inside the endless belt or form the curved portion outside the endless belt, it is possible to suppress an increase in the size of the carriage.

A sixth aspect is an aspect according to the fifth aspect, wherein the first belt accommodation section and the second belt accommodation section are disposed with the belt fixing section interposed therebetween in a direction along the first axis.

According to this aspect, since the first belt accommodation section and the second belt accommodation section are disposed with the belt fixing section interposed therebetween in the direction along the first axis, this makes it possible to reduce variation in the magnitude of the moment applied to the carriage when the carriage is pulled in the first direction and when the carriage is pulled in the second direction, thereby making it possible to obtain good recording quality.

A seventh aspect is an aspect according to the sixth aspect, wherein assuming that a first straight line is a straight line that passes through a center position of the belt fixing section with respect to a direction along the first axis in a side view of the endless belt and that is orthogonal to the first axis and the first belt accommodation section and the second belt accommodation section are provided so as to be line-symmetrical with respect to the first straight line.

According to this aspect, since the first belt accommodation section and the second belt accommodation section are provided so as to be line-symmetrical with respect to the first straight line, this makes it possible to equalize the magnitude of the moment applied to the carriage when the carriage is pulled in the first direction and when the carriage is pulled in the second direction, thereby obtaining good recording quality.

Hereinafter, the present disclosure will be described in detail.

Hereinafter, an inkjet printer 1 that performs recording by ejecting ink, which is an example of liquid, onto a medium such as recording sheet, will be described as an example of a recording device. Hereinafter, the inkjet printer 1 will be referred to simply as a printer 1.

An X-Y-Z coordinate system shown in each drawing is an orthogonal coordinate system, and a Y-axis direction is a transport direction of a medium during recording and also the depth direction of the device. In each of the X-axis, the Y-axis, and the Z-axis, a direction indicated by an arrow is defined as a + direction, and an opposite direction is defined as a - direction. In the present embodiment, among the side surfaces constituting the periphery of the printer 1, the side surface in the + Y direction is the front surface, and the side surface in the - Y direction is the back surface.

An X-axis direction is a device width direction and, as viewed from an operator of the printer 1, a +X direction is to a left side and a -X direction is to a right side. The X-axis direction is the medium width direction. Hereinafter, the X-axis direction may be simply referred to as a width direction. The X-axis is an example of a first axis, the + X direction is an example of a first direction, and the - X direction is an example of a second direction.

A Z-axis direction is a vertical direction, that is, a device height direction, a +Z direction is an upward direction, and a -Z direction is a downward direction.

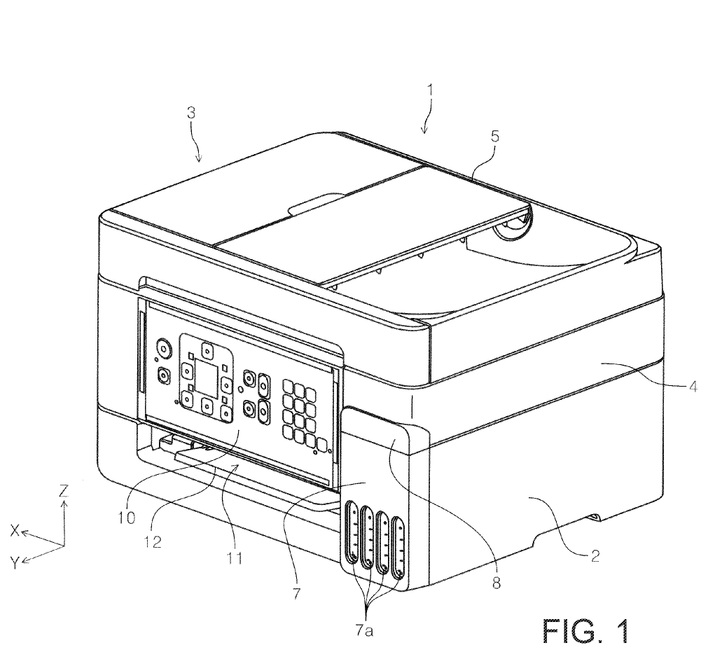

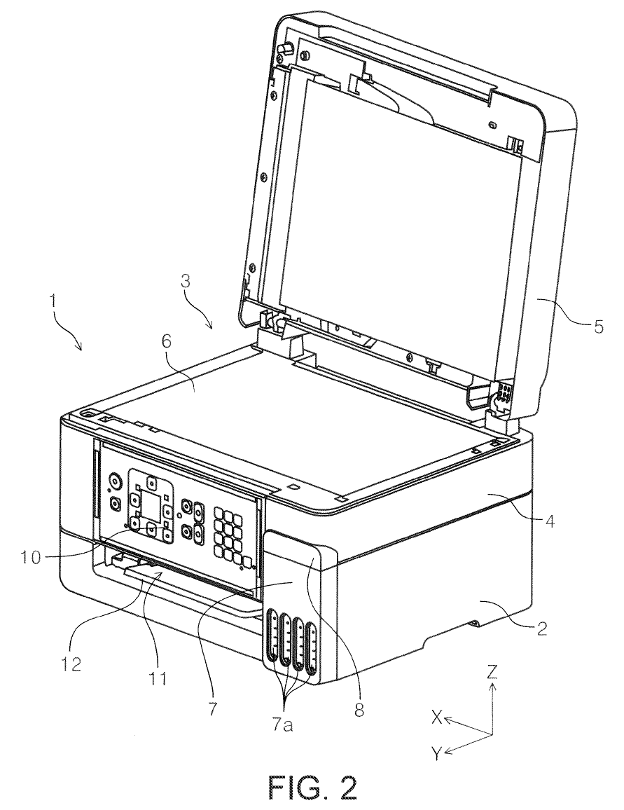

As shown in FIG. 1, the printer 1 is configured as a multifunction machine including a recording unit 2 and a scanner section 3 disposed on the recording unit 2. The scanner section 3, as an image reading section that reads an image of a document, includes a reading section 4 and an automatic document feed section 5 provided above the reading section 4. The automatic document feed section 5 is provided to be rotatable with respect to the reading section 4 and, when the automatic document feed section 5 is opened, a document table 6 constituting the reading section 4 is exposed as shown in FIG. 2. A reading sensor (not shown) is provided below the document table 6. The automatic document feed section 5 transports a document to a reading position of a reading sensor.

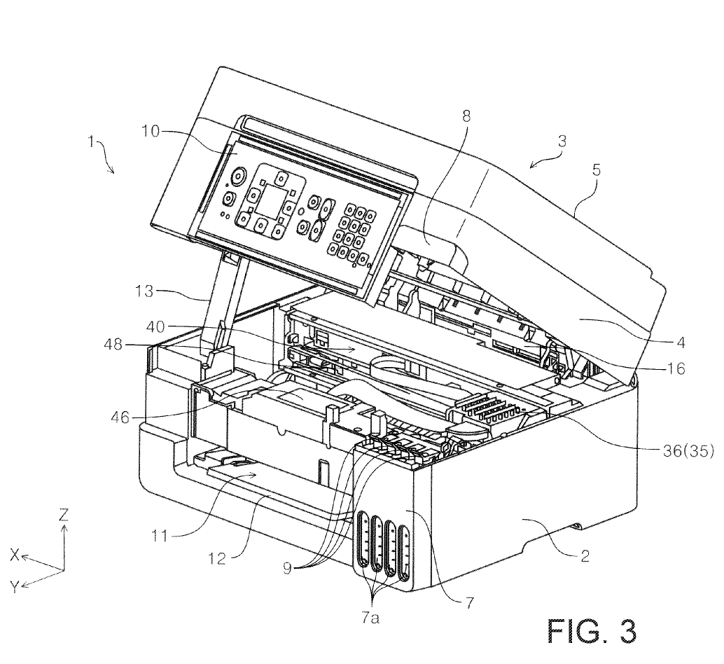

The scanner section 3 is rotatably connected to the recording unit 2 via a rotation shaft 3a (refer to the 8A of the drawing), and can take a closed state as shown in FIG. 1 and an open state as shown in FIG. 3 by rotating. In FIG. 3, reference numeral 13 denotes a support arm, and the support arm 13 holds the scanner section 3 in an open state.

When the scanner section 3 is opened, the inside of the recording unit 2 is exposed.

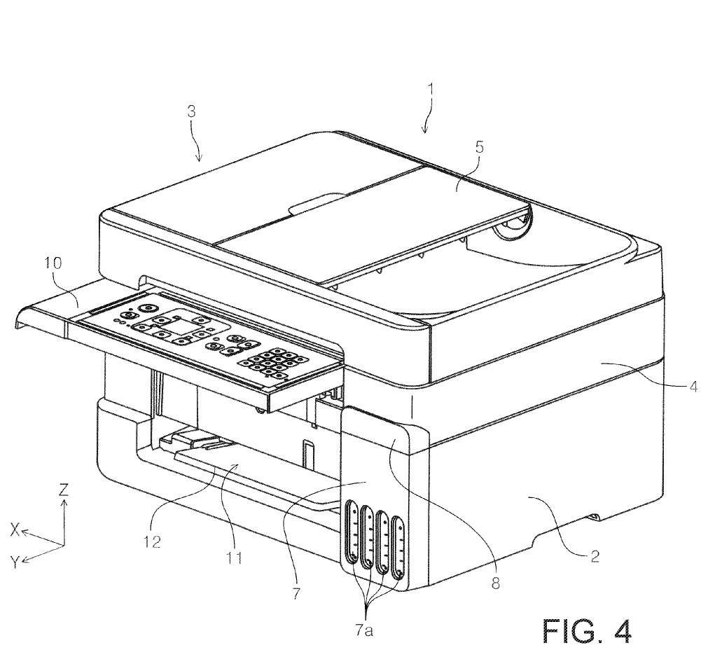

In FIG. 1, an operation panel 10 is provided on the front side of the recording unit 2. The operation panel 10 is tiltable, and can take a state in which a panel surface is along a vertical direction as shown in FIG. 1 and a state in which the panel surface faces upward as shown in FIG. 4.

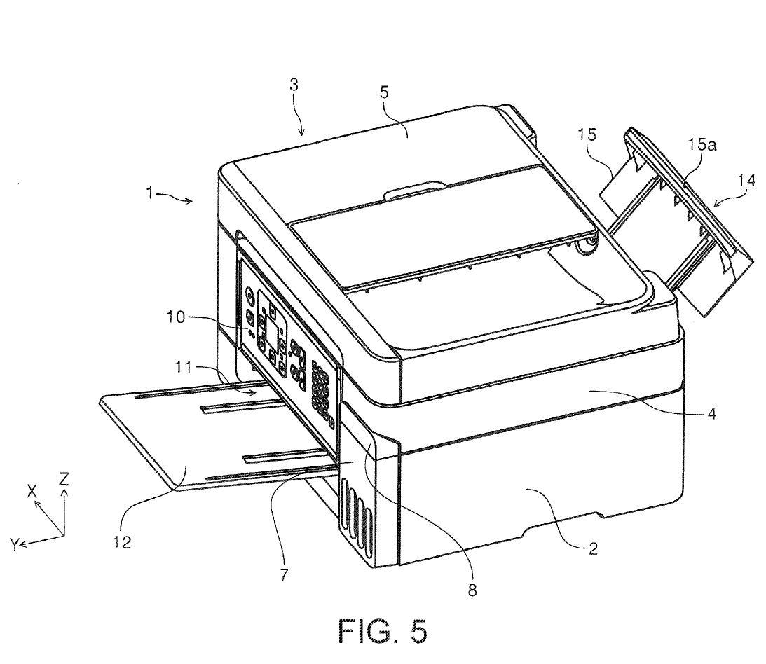

A discharge port 11 is formed on the front side of the recording unit 2. A medium receiving tray 12 is provided at the discharge port 11. The medium receiving tray 12 is configured to be switchable with respect to the recording unit 2 between a stored state shown in FIG. 1 and a pulled-out state shown in FIG. 5.

An ink storage section 7 is provided on the front side of the recording unit 2. The ink storage section 7 can store a plurality of colors of ink, for example, yellow, magenta, cyan, and black inks. A remaining ink amount viewing window 7a for viewing the remaining amount of ink is provided on the front surface side of the ink storage section 7.

A cover 8 is provided on the upper portion of the ink storage section 7. The cover 8 is provided integrally with the scanner section 3, and when the scanner section 3 is opened, the upper portion of the ink storage section 7 is exposed as shown in FIG. 3.

In FIG. 3, reference numeral 9 denotes a cap lever. The cap lever 9 is openable and closable, and an ink inlet (not shown) can be exposed by opening the cap lever 9. Ink can be replenished from the ink inlet.

As shown in FIGS. 5, 6, and 8A of the drawings, a medium support section 14 that supports medium in an inclined posture before feeding is provided on the rear surface side of the recording unit 2.

The medium support section 14 includes a support section 15 and a swing support section 16. The swing support section 16 is swingable about a swing shaft 16a (see the 8A in the drawing), and swings by receiving power of a motor (not shown), thereby bringing the supported medium into contact with a feed roller 23.

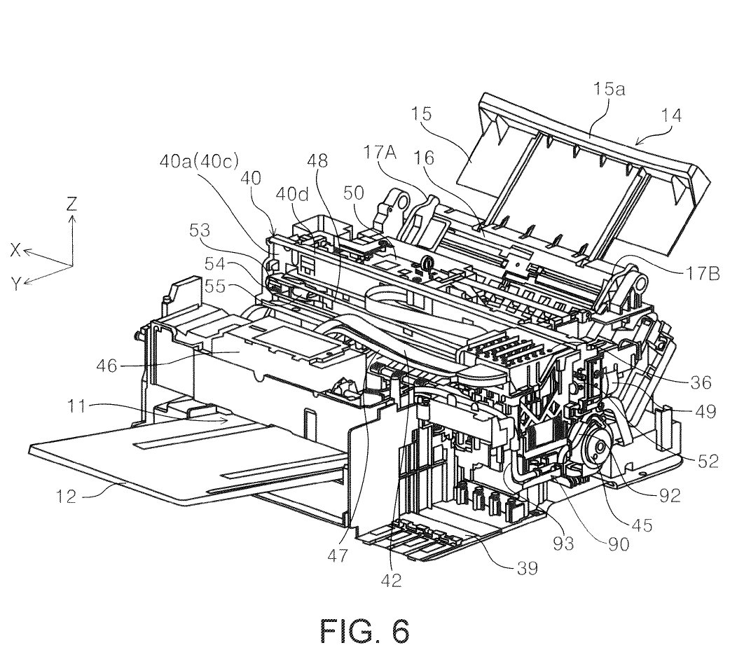

As shown in FIG. 6, the swing support section 16 is provided with edge guides 17A and 17B for guiding edges of the medium in the widthwise direction. The edge guides 17A and 17B are provided so as to approach or separate from each other along the widthwise direction of the medium by a rack and pinion mechanism (not shown).

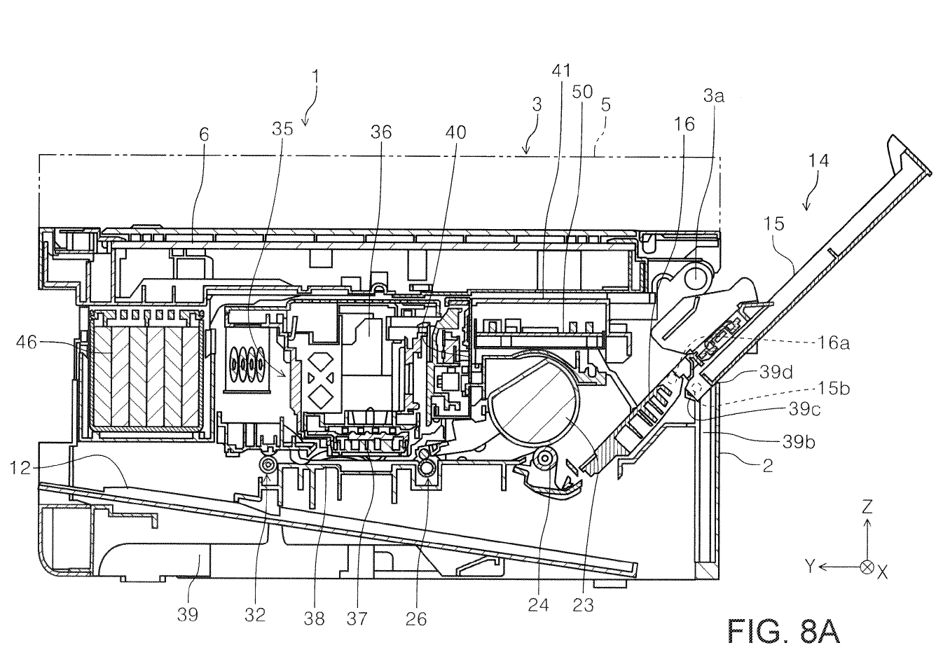

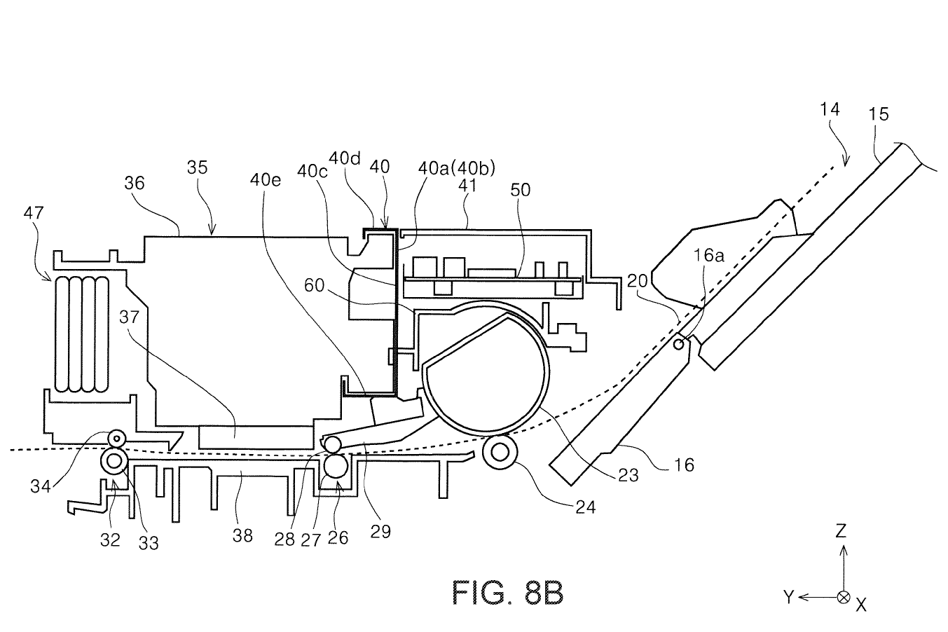

The support section 15 can take an expanded state shown in FIGS. 5, 6, and 8A of the drawings and a stored state (not shown). The support section 15 takes an inclined posture in the expanded state shown in FIGS. 5, 6, and 8A of the drawing. The support section 15 is in a vertical posture in a stored state (not shown) and is stored on the back side of the base frame 39. As shown in the FIG. 8A, a guide section 39b extending in the vertical direction is formed on the back side of a base frame 39 that constitutes the base of the recording unit 2. A swing shaft 15b is formed in the support section 15, and the swing shaft 15b is provided to be movable along the vertical direction in the guide section 39b.

In the stored state of the support section 15, the swing shaft 15b is located at the lower end portion of the guide section 39b. When the user pulls up the support section 15 from this state to set the support section 15 in the inclined posture, the swing shaft 15b enters the holding section 39c provided on the upper portion of the guide section 39b. The back surface side of the support section 15 contacts against the contact section 39d of the base frame 39, and the inclined posture is maintained.

As shown in FIG. 6, a curved support section 15a is formed on the upper portion of the support section 15. The medium supported by the support section 15 is formed by the curved support section 15a into a curve that is convex downward along the widthwise direction, and by this, the upper end portion of the medium are suppressed from hanging down backward.

Hereinafter, a medium transport path 20 in the recording unit 2 will be described with reference to FIG. 8B. Note that FIG. 8B is an outline of the configuration shown in FIG. 8A which is extracted as appropriate.

Hereinafter, a direction in which the medium is transported may be referred to as "downstream", and an opposite direction of it may be referred to as "upstream". In FIG. 8B, the medium transport path 20 is indicated by broken line. In the printer 1, the medium is transported through the transport path 20.

The above-described medium support section 14 is provided at the most upstream side of the transport path 20.

The medium supported by the medium support section 14 is nipped and separated by a feed roller 23 driven by a motor (not shown) and a separation roller 24 to which a rotational resistance is applied, and is sent toward a transport roller pair 26.

The transport roller pair 26 includes a transport drive roller 27 driven by a transport motor (not illustrated) and a transport driven roller 28 that nips the medium between the transport drive roller 27 and the transport driven roller 28. The transport driven roller 28 is rotatably supported by a roller support member 29.

In the present embodiment, the transport drive roller 27 is a shaft body extending in the width direction. In the embodiment, a plurality of the transport driven rollers 28 are provided at appropriate intervals along the width direction with respect to the transport drive roller 27.

In the present embodiment, two transport driven rollers 28 are supported by one roller support member 29.

The roller support member 29 is swingably attached to the main frame 40 via a swing shaft (not shown), and the transport driven roller 28 advances and retreats with respect to the transport drive roller 27 by swinging. The roller support member 29 is pressed in a direction in which the transport driven roller 28 advances with respect to the transport drive roller 27 by a pressing member (not shown), for example, a torsion spring or a tension spring.

The recording section 35 includes a carriage 36 and a recording head 37. The carriage 36 is supported by the main frame 40 and guided in the width direction. The carriage 36 reciprocates in the width direction by receiving power of a carriage motor 49 (refer to FIG. 6).

A recording head 37 is provided below the carriage 36. The recording head 37 is provided with a plurality of ink ejection nozzles (not shown) capable of ejecting ink in the - Z direction. The ink storage section 7 and the carriage 36 described above are connected by an ink tube 47, and ink is supplied from the ink storage section 7 through the ink tube 47.

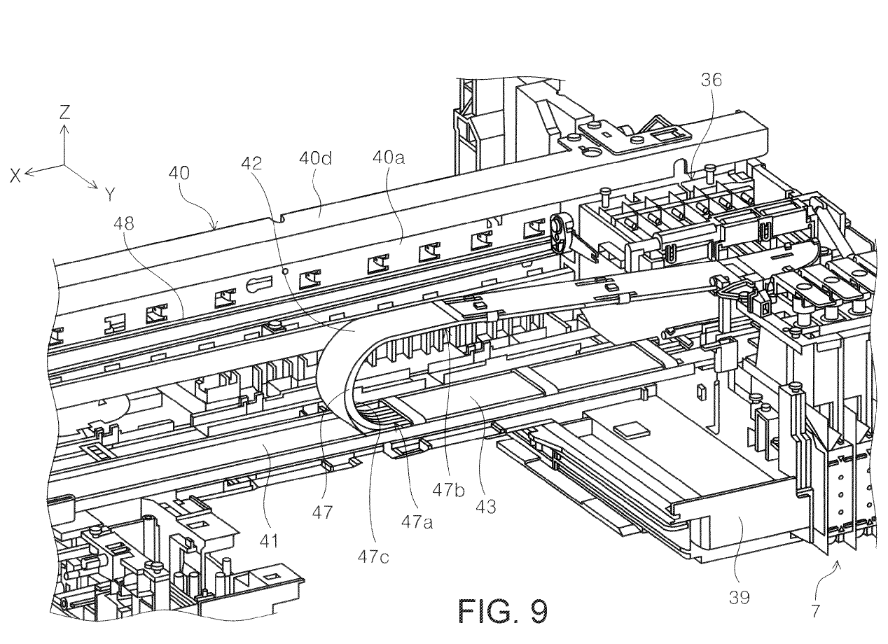

As shown in FIG. 9, the ink tube 47 extends from the ink storage section 7 in the + X direction, is curved upward, is folded back in the - X direction, and enters the carriage 36. Reference numeral 41 denotes a frame for supporting the ink tube 47. The ink tube 47 moves in the X-axis direction at the curved section 47c by the movement of the carriage 36 along the X-axis.

Reference numeral 42 denotes a sheet material that is disposed along the outer side of the curve of the ink tube 47. The sheet material 42 has flexibility. The sheet material 42 can be formed of a resin material, and polyethylene terephthalate can be adopted as an example.

Hereinafter, the portion of the ink tube 47 that extends from the ink storage section 7 in the + X direction to the curved section 47c is referred to as a lower tube section 47a. The portion of the ink tube 47 that extends from the curved section 47c in the - X direction and that enters the carriage 36 is referred to as an upper tube section 47b. The upper tube section 47b is located above the lower tube section 47a.

When the carriage 36 moves, the length of the lower tube section 47a and the length of the upper tube section 47b in the X-axis direction change. For example, when the carriage 36 is positioned farthest in the - X direction, the length of the lower tube section 47a in the X-axis direction is the shortest, and the length of the upper tube section 47b in the X-axis direction is the longest. For example, when the carriage 36 is positioned at the most + X direction side, the length of the lower tube section 47a in the X-axis direction becomes the longest, and the length of the upper tube section 47b in the X-axis direction becomes the shortest.

Here, since the upper tube section 47b tends to hang down, sometimes the hanging upper tube section 47b contacts the lower tube section 47a. This is likely to occur when the carriage 36 moves in the +X direction from a state in which it is positioned furthest in the -X direction, particularly in a high temperature environment. There is a risk that upper tube section 47b and the lower tube section 47a that contact each other might stick together. When such sticking together occurs, there is a risk that appropriate deformation of the ink tube 47 according to the movement of the carriage 36 is hindered, and that the carriage 36 cannot move.

In order to suppress such a problem, a sheet material 43 is provided on the upper surface of the lower tube section 47a. The sheet material 43 can be formed of a resin material, and polyethylene terephthalate can be adopted as an example. The frictional coefficient between the sheet material 43 and the ink tube 47 is lower than the friction coefficient between the upper tube section 47b and the lower tube section 47a.

By providing such a sheet material 43, it is possible to suppress that the upper tube section 47b and the lower tube section 47a stick together, and thus, it is possible to suppress the movement of the carriage 36 from being hindered.

Note that in the printer 1 according to the embodiment, the ink storage section 7 is independent of the carriage 36, but the ink storage section 7 may be provided in the carriage 36.

Further, the recording method is not limited to the ink jet method, and may be a dot impact method, a thermal method, or the like.

Next, returning to FIG. 8B, a support member 38 for supporting a medium is provided at a position that can face the recording head 37. The support member 38 defines a distance between the medium and the recording head 37. The recording head 37 ejects ink onto the medium supported by the support member 38, and performs recording on the recording surface of the medium. The medium on which recording was performed is nipped by a discharge roller pair 32 provided downstream of the recording head 37 in the transport path 20, and is discharged toward the medium receiving tray 12.

The discharge roller pair 32 includes a discharge drive roller 33 that is driven by a transport motor (not shown) and a discharge driven roller 34 that nips the medium between the discharge drive roller 33 and the discharge driven roller 34.

In the present embodiment, a plurality of discharge roller pairs 32 are provided at appropriate intervals along the width direction. In the present embodiment, the discharge driven roller 34 is a toothed roller having teeth on the outer periphery thereof. The discharge driven roller 34 is capable of advancing and retreating with respect to the discharge driving roller 33, and nips the medium between the discharge drive roller 33 and the discharge driven roller 34 by using a rod spring as a rotation shaft.

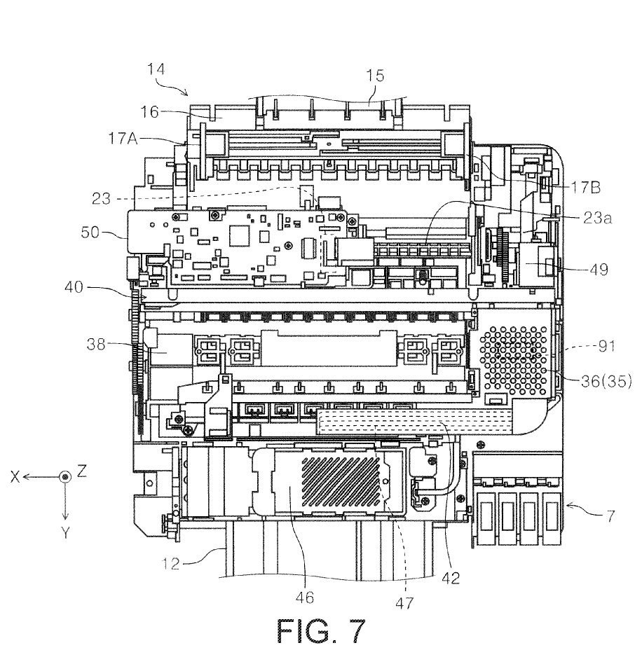

Note that as shown in FIG. 6, a maintenance unit 90 is provided at an end portion in the - X direction in the reciprocating region of the carriage 36. The maintenance unit 90 is provided with a cap 91 (see FIG. 7) capable of sealing the ink ejection surface of the recording head 37. A suction pump 45 is provided at a position adjacent to the maintenance unit 90, and the suction pump 45 and the cap 91 are connected by a tube 92. By this, when the suction pump 45 is operated, a negative pressure is supplied into the cap 91, and the waste ink is sucked from the cap 91.

The waste ink sucked by the suction pump 45 is sent to a waste liquid storage section 46 through the tube 93 and collected. The waste liquid storage section 46 is provided in an upper portion on the front side of the device.

The suction pump 45 is driven by a transport motor (not shown). If the rotation direction of the transport motor when the medium is transported downstream is a forward rotation direction, the suction pump 45 operates only when the transport motor rotates in a reverse rotation direction.

Next, the main frame 40 will be described. The main frame 40 is a frame that constitutes a base body of the recording unit 2. Referring to FIG. 8B, the main frame 40 is formed by bending a metallic plate material so as to have a vertical frame section 40a, an upper bent section 40d, and a lower bent section 40e. The end portion of the upper bent section 40d in the + Y direction is further bent in the - Z direction. The end of the lower bent section 40e in the + Y direction is further bent in the + Z direction.

The vertical frame section 40a is a portion that forms a surface parallel to the X-Z plane. The vertical frame section 40a has a first frame surface 40b which is a surface on the back surface side, and a second frame surface 40c which is a surface on the front surface side and is a surface opposite to the first frame surface 40b.

The upper bent section 40d and the lower bent section 40e are portions forming surfaces parallel to the X-Y plane.

The main frame 40 is located between the medium support section 14 and the recording section 35, the first frame surface 40b faces the feed roller 23, and the second frame surface 40c faces the recording section 35. A main board 50 is provided on the back side of the main frame 40.

A carriage motor 49 (refer to FIG. 6) is provided on the vertical frame section 40a on the side of the first frame surface 40b. An endless belt 48 (see FIG. 6) for pulling the carriage 36 is provided on the vertical frame section 40a on the side of the second frame surface 40c.

A roller support member 29 is swingably supported on the lower bent section 40e. The lower bent section 40e supports the carriage 36 and guides the carriage 36 in the widthwise direction.

The drive pulley 52 is provided at the end portion in the - X direction of the second frame surface 40c of the vertical frame section 40a. The driven pulley 53 is provided at the end portion in the + X direction of the second frame surface 40c of the vertical frame section 40a. The endless belt 48 is wound around the drive pulley 52 and the driven pulley 53. The drive pulley 52 is provided on a rotation shaft of the carriage motor 49.

The driven pulley 53 is supported by the holder 54. The holder 54 is provided so as to be displaceable in the X-axis direction in the vertical frame section 40a, and is pressed in the + X direction by a compression coil spring 55, which is an example of a pressing member. By this, tension along the X-axis direction is applied to the endless belt 48.

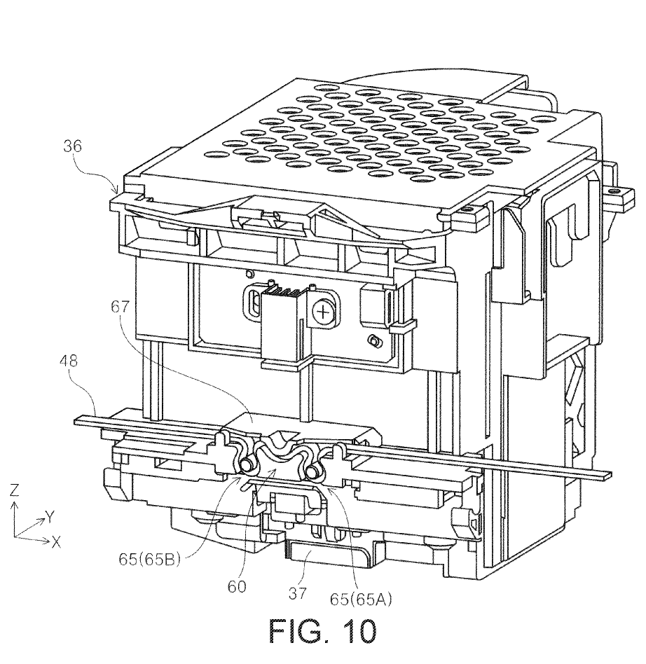

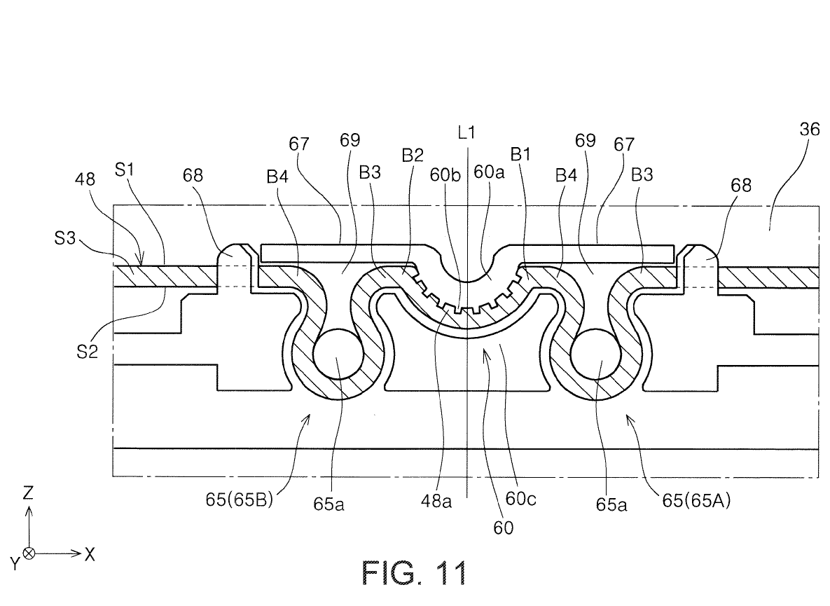

As shown in FIGS. 10 and 11, a belt fixing section 60 and a belt accommodation section 65 are provided on a side surface in the -Y direction of the carriage 36, that is, a back surface. The belt fixing section 60 is a portion to which the endless belt 48 is fixed. The belt accommodation section 65 is a portion that accommodates a part of the endless belt 48 in a curved manner. Hereinafter, the belt fixing section 60 and the belt accommodation section 65 will be described in detail with reference to FIG. 11. Note that in FIG. 11, the endless belt 48 is hatched for convenience of illustration. FIG. 11 is a front view of the side surface S3 of the endless belt 48.

The endless belt 48 has an inner peripheral surface S1, an outer peripheral surface S2, and a side surface S3. The inner peripheral surface S1 is a surface that engages with the outer peripheral surface of the drive pulley 52 (see FIG. 6) and the outer circumferential surfaces of the driven pulley 53 (see FIG. 6). Tooth sections 48a are formed in the inner peripheral surface S1 at predetermined intervals over the entire length direction. However, FIG. 11 illustrates only tooth sections 48a that engage with the belt fixing section 60, and the other tooth sections 48a are omitted.

In the present embodiment, one belt fixing section 60 is provided. The belt fixing section 60 is provided so as to receive a part of the endless belt 48 in a curved state by an inner portion 60a and an outer portion 60c. The inner portion 60a is provided with a plurality of engagement sections 60b that can engage with the tooth sections 48a of the endless belt 48. A portion of the endless belt 48 enters the belt fixing section 60, and thus the portion of the endless belt 48 is fixed to the carriage 36. By a portion of the endless belt 48 being fixed to the carriage 36, the carriage 36 is pulled in the + X direction or the - X direction by the endless belt 48.

Next, in the present embodiment, two belt accommodation sections 65 are provided. One of the two belt accommodation sections 65 is referred to as a first belt accommodation section 65A, and the other is referred to as a second belt accommodation section 65B. Note that when it is not necessary to distinguish the first belt accommodation section 65A and the second belt accommodation section 65B, they are simply referred to as a belt accommodation section 65.

The belt accommodation section 65 is provided so as to storage a part of the endless belt 48 in a curved state by winding the part of the endless belt 48 around the inner portion 65a. In the present embodiment, the inner portion 65a is not formed with an engagement section that can engage with the tooth sections 48a of the endless belt 48.

Note that a cover section 67 is formed on the + Z direction side of the belt accommodation section 65 so as to extend in the X-axis direction. In the present embodiment, the cover section 67 and the inner portion 60a of the belt fixing section 60 are integrally formed.

A shortcut passage 69 through which the endless belt 48 can pass is formed between the cover section 67 and the inner portion 65a. Therefore, by using the shortcut passage 69, the endless belt 48 can be linearly routed without being accommodated in the belt accommodation section 65.

Note that reference numeral 68 denotes a regulating section that regulates the endless belt 48 so that it does not come off in the - Y direction.

As described above, the carriage 36 includes the belt fixing section 60 that fixes the endless belt 48 and the belt accommodation section 65 that accommodates a portion of the endless belt 48 in a curved manner. Therefore, by accommodating a part of the endless belt 48 in the belt accommodation section 65, the circumferential length of the endless belt 48 can be shortened as compared with a case where a part of the endless belt 48 is not accommodated in the belt accommodation section 65. In other words, even when the endless belt 48 has an excess length, the excess length of the endless belt 48 can be absorbed by the belt accommodation section 65. By this, the endless belt 48 can be used in common for a plurality of products having different specifications, and thus, management is facilitated and an increase in cost can be suppressed.

In the present embodiment, the endless belt 48 has a plurality of tooth sections 48a arranged along the longitudinal direction. The belt fixing section 60 has an engagement section 60b that engages with the tooth sections 48a, and the belt accommodation section 65 does not have an engagement section that engages with the tooth sections 48a.

If the belt accommodation section 65 is provided with an engagement section that engages with the tooth section 48a, there is a risk that a deflection portion may be formed in the endless belt 48 between the belt fixing section 60 and the belt accommodation section 65. If a deflection portion is formed in the endless belt 48 between the belt fixing section 60 and the belt accommodation section 65, the circumferential length of the endless belt 48 may be different from the intended circumferential length.

However, according to the present embodiment, since the belt accommodation section 65 is not provided with the engagement section, it is possible to suppress the circumferential length of the endless belt 48 from being different from the intended circumferential length.

However, the belt accommodation section 65 may be provided with an engagement section that engages with the tooth section 48a.

In the present embodiment, the belt fixing section 60 and the belt accommodation section 65 are disposed side by side along the X-axis.

In FIG. 11, the endless belt 48 has a first portion B1 extending from the belt fixing section 60 in the + X direction, a second portion B2 extending from the belt fixing section 60 in the - X direction, a third portion B3 extending from the belt accommodation section 65 in the + X direction, and a fourth portion B4 extending from the belt accommodation section 65 in the - X direction. The first portion B1, the second portion B2, the third portion B3, and the fourth portion B4 are linearly arranged along the X-axis. In other words, the positions in the Z-axis direction of the first portion B1, the second portion B2, the third portion B3, and the fourth portion B4 coincide with each other.

When the endless belt 48 is pulling the carriage 36, the first portion B1, the second portion B2, the third portion B3, and the fourth portion B4 are portions in FIG. 11 that apply force to the carriage 36 that attempts to rotate the carriage 36. Therefore, in a case where the respective portions are not arranged in a straight line along the X-axis, the magnitude of moment applied to the carriage 36 is different when the carriage 36 is pulled in the + X direction and when the carriage 36 is pulled in the - X direction, and there is a concern that the recording quality may be adversely affected.

However, according to the present embodiment, since the first portion B1, the second portion B2, the third portion B3, and the fourth portion B4 are linearly arranged along the X-axis, the adverse effect described above can be suppressed.

In the embodiment, the carriage 36 includes a first belt accommodation section 65A and a second belt accommodation section 65B as belt accommodation sections 65. This further improves the degree of freedom in adjusting the circumferential length of the endless belt 48.

For example, the circumferential length of the endless belt 48 can be made different between a case where the endless belt 48 is not accommodated in any of the first belt accommodation section 65A and the second belt accommodation section 65B, a case where the endless belt 48 is accommodated in one of the first belt accommodation section 65A and the second belt accommodation section 65B, and a case where the endless belt 48 is accommodated in both the first belt accommodation section 65A and the second belt accommodation section 65B.

Note that only one belt accommodation section 65 may be provided, or three or more belt accommodation sections 65 may be provided. In a case where a plurality of belt accommodation sections 65 are provided, the belt accommodation sections 65 may have different belt accommodation lengths. The belt accommodation length can be adjusted by changing the curvature of the curve, for example. With this configuration, the variation of setting the circumferential length of the endless belt 48 is further increased. For example, in the present embodiment, the belt accommodation length of the first belt accommodation section 65A may be shorter than the belt accommodation length of the second belt accommodation section 65B. In a case where three belt accommodation sections 65 are provided, the belt accommodation lengths of all the belt accommodation sections 65 may be different from each other, or the belt accommodation length of one belt accommodation section 65 may be different from the belt accommodation lengths of the other two belt accommodation sections 65.

In the present embodiment, the belt fixing section 60 as well as the first belt accommodation section 65A and the second belt accommodation section 65B form curved portions outside the endless belt 48.

That is, in a case where the belt fixing section 60 as well as the first belt accommodation section 65A and the second belt accommodation section 65B form curved portions in the endless belt 48, three curved portions are formed in the endless belt 48 in the carriage 36. If, for example, the curved portion of the first belt accommodation section 65A among the curved portions is located outside the endless belt 48 and the curved portion of the second belt accommodation section 65B is located inside the endless belt 48, the carriage 36 needs to have spaces outside and inside the endless belt 48, which may increase the size of the carriage 36.

However, according to the present embodiment, the belt fixing section 60 as well as the first belt accommodation section 65A and the second belt accommodation section 65B form curved portions on the outer side of the endless belt 48, and thus, it is possible to suppress an increase in the size of the carriage 36.

Note that instead of a configuration in which the belt fixing section 60 and the first belt accommodation section 65A and the second belt accommodation section 65B form a curved portion on the outside of the endless belt 48, they may be configured to form a curved portion on the inside of the endless belt 48.

In the present embodiment, the first belt accommodation section 65A and the second belt accommodation section 65B are disposed with the belt fixing section 60 interposed therebetween in the X-axis direction. By this, this makes it possible to reduce variation in the magnitude of the moment applied to the carriage 36 when the carriage 36 is pulled in the +X direction and when the carriage 36 is pulled in the -X direction, thereby making it possible to obtain good recording quality.

In the present embodiment, as shown in FIG. 11, a first straight line L1 is a straight line that passes through the X-axis direction center position of the belt fixing section 60 in a side view of the endless belt 48 and that is perpendicular to the X-axis. The first belt accommodation section 65A and the second belt accommodation section 65B are provided so as to be line-symmetrical with respect to the first straight line L1. By this, this makes it possible to equalize the magnitude of the moment applied to the carriage 36 when the carriage 36 is pulled in the +X direction and when the carriage 36 is pulled in the -X direction, thereby obtaining good recording quality.

The present disclosure is not limited to the embodiments and modifications described above, various modifications are possible within the scope of the disclosure described in the claims, it is needless to say that they are also included in the scope of the present disclosure.

What is claimed is:

1. A recording device comprising:
a recording head that performs recording on a medium;
a carriage that includes the recording head and that moves in a first direction which is a direction along a first axis and a second direction which is a direction along the first axis and which is opposite to the first direction; and
an endless belt configured to pull the carriage in the first direction and in the second direction, wherein
the carriage includes
a belt fixing section that fixes the endless belt and
a belt accommodation section that accommodates a part of the endless belt in a curved manner.

2. The recording device according to claim 1, wherein
the endless belt includes a plurality of tooth sections arranged along a belt length direction,
the belt fixing section includes an engagement section that engages with the tooth sections, and
the belt accommodation section does not include an engagement section that engages with the tooth sections.

3. The recording device according to claim 2, wherein
the belt fixing section and the belt accommodation section are arranged side by side along the first axis,
the endless belt includes
a first portion extending from the belt fixing section in the first direction,
a second portion extending from the belt fixing section in the second direction,
a third portion extending from the belt accommodation section in the first direction, and
a fourth portion extending from the belt accommodation section in the second direction, and
the first portion, the second portion, the third portion, and the fourth portion are arranged linearly along the first axis.

4. The recording device according to claim 1, wherein
assuming that the belt accommodation section is a first belt accommodation section, the carriage includes a second belt accommodation section in addition to the first belt accommodation section, the second belt accommodation section accommodating a part of the endless belt in a curved manner.

5. The recording device according to claim 4, wherein
the belt fixing section, the first belt accommodation section, and the second belt accommodation section form a curved portion inside the endless belt or form a curved portion outside the endless belt.

6. The recording device according to claim 5, wherein
the first belt accommodation section and the second belt accommodation section are disposed with the belt fixing section interposed therebetween in a direction along the first axis.

7. The recording device according to claim 6, wherein
assuming that a first straight line is a straight line that passes through a center position of the belt fixing section with respect to a direction along the first axis in a side view of the endless belt and that is orthogonal to the first axis and
the first belt accommodation section and the second belt accommodation section are provided so as to be line-symmetrical with respect to the first straight line.
